(19) United States
(12) Patent Application Publication
(10) Pub. No.: US 2006/0024125 A1
(43) Pub. Date: Feb. 2, 2006

(54) Apparatus for storing photographs and other memorabilia

(76) Inventors: Emily G. Johnson, Walnut Creek, CA (US); Carrie L. Edwards, Walnut Creek, CA (US); Henry C.J. Hoogland III, Salt Lake City, UT (US)

Correspondence Address: MADSON & METCALF;GATEWAY TOWER WEST, SUITE 900, 15 WEST SOUTH TEMPLE, SALT LAKE CITY, UT, 84101, US

(21) Appl. No.: 11/237,567

(22) Filed: Sep. 28, 2005

Related U.S. Application Data
(63) Continuation of application No. 10/990,343, filed on Nov. 16, 2004.
(60) Provisional application No. 60/520,952, filed on Nov. 18, 2003.

(51) Int. Cl. B42F 13/00

(52) U.S. Cl. 402/73

(57) ABSTRACT

A storage system and apparatus for storing photographs and other memorabilia is disclosed. The storage system includes a novel storage binder having a plurality of panels that may be arranged in such a manner as to form an enclosure. The storage system also includes novel loose-leaf binder inserts for placement inside the storage binder. The loose-leaf binder inserts may include a transparent front sheet attached to a backing to form a number of memorabilia-receiving sleeves therein. Vertically-oriented sleeve openings may be formed in the backing for insertion of photographs or other memorabilia. The front sheet and backing may be folded in half, or otherwise attached to have a two-sided binder insert with transparent front sheets exposed on the outside of the insert and the corresponding backing located on the inside of the insert.

### RELATED APPLICATIONS

This application claims the benefit of U.S. Provisional Patent Application Ser. No. 60/520,952, filed Nov. 18, 2003 and entitled APPARATUS AND METHODS FOR STORING PHOTOGRAPHS AND OTHER MEMORABILIA, which is incorporated herein by reference.

### TECHNICAL FIELD

The present invention relates generally to devices for retaining visual material. More specifically, the present invention relates to binders, loose-leaf binder inserts and similar systems for storing photographs, scrapbooking material and other memorabilia.

### BACKGROUND OF THE INVENTION

Typically, known loose-leaf binders are constructed of a binding having a spine hingedly attached between a front panel and a back panel. Located on the spine of traditional loose-leaf binders are retaining mechanisms, such as D-rings, posts, tabs, rods and the like. These retaining mechanisms are typically located along the length of the spine, and can be actuated to selectively retain loose-leaf inserts or pages. Typically, the retaining mechanism engages one or more openings formed in a loose-leaf insert or page. The loose-leaf inserts may be selectively introduced into the binder and retained therein.

The loose-leaf inserts are often used for receiving visual material such as a single sheet of paper, photographs, paper crafts, etc. Often loose-leaf binders and their associated inserts are used for scrapbooking purposes. A scrapbook is a collection of scrapbook pages, each of which is a unique collection of items such as photographs, paper crafts and journaling. In general, each scrapbook page or a group of pages are based on a theme, and all of the components that make up those pages are in context with the theme.

Loose-leaf inserts often take the form of sheet protectors that are constructed out of two layers of plastic material commonly made from sheets of polyolefin, such as polypropylene, polyethylene, or sheets of polyvinyl chloride. These sheets of material may form sleeves for receiving memorabilia and are substantially transparent to permit viewing of the visual material that is deposited therein. Structurally these sleeves may take the form of a receiving pocket that is formed along a series of parallel spaced sealing lines and perpendicular spaced sealing lines. These sealing lines define a rectangular sleeve between three sealing lines. An open end or slit may be formed across the top of each sleeve to provide for selectively introducing or removing memorabilia.

In conventional album systems, the sleeves of loose-leaf inserts may be sized to receive a sheet of paper, wherein only one sleeve exists per sheet, or they may be sized to receive multiple photographs, wherein there exists multiple sleeves of the same size. A disadvantage with conventional loose-leaf inserts is their general inability to retain the insertable contents. For example, it is not uncommon for an individual to accidentally pick up a conventional album upside-down. Gravity may cause the contents of each sleeve to escape because the sleeve has its opening exposed downward. This could be especially troublesome considering the priceless value most individuals subscribe to their memorabilia. Moreover, in the context of storing trading cards, the cards have a definite market value that is directly proportional to the condition of the card. If a card falls out of its sleeve, it may become damaged as it falls to the ground.

Furthermore, the front and back panels of conventional binders that hold the loose-leaf inserts act like covers of a book (i.e., they cover and protect the face of loose-leaf inserts or pages inserted therein). However, typical loose-leaf binders do not cover the edges of the inserts. This leaves the loose-leaf inserts exposed, so that they may become damaged or the contents therein may become lost. For example, the effects of gravity may also create stress on the retention holes of the loose-leaf insert. Continued stress on loose-leaf inserts may cause the retention holes to tear through the insert, rendering the insert inoperable and possibly losing or damaging the contents therein.

One known method for approaching this problem is to store the conventional binders into a box or similar receptacle. However, this approach may be unsuitable because it requires the use of multiple components and is not necessarily an aesthetically pleasing alternative.

Consequently it would be an advancement in the art to have a memorabilia storage system that allows for the safe storage of photographs, scrapbooking and other memorabilia while keeping the system aesthetically pleasing. It would further be an advantage in the art to provide a memorabilia storage system with loose-leaf inserts that are configured to prevent the loss of material that is inserted therein even if the memorabilia binder is turned upside-down. It would also be advantageous to provide a memorabilia storage system to counter the adverse effects that gravity has on conventional systems. It is also desirable to have a system that provides a template allowing a user to easily remove and/or rearrange memorabilia. It is further desirable to provide for a system that allows for the storage of extra photographs, negatives and digital media in proximity with the memorabilia sought to be displayed.

The present invention as disclosed and claimed herewith meets these needs.

### BRIEF SUMMARY OF THE INVENTION

A memorabilia storage binder is disclosed. According to one embodiment, the storage binder includes a front and a back panel. A spine panel interconnects the front and back panels and is hingedly attached to both panels. The spine panel has a loose-leaf insert retaining mechanism coupled thereto. The storage binder also includes three side panels that can be oriented in a substantially perpendicular position with respect to the front and back panels. All the panels of the binder form an enclosure.

Two of the side panels of the storage binder may be rigidly attached to the top and bottom edges of the back panel. The third side panel may be rigidly attached to a side edge of the back panel. The storage binder may then also have a fourth side panel that is hingedly attached to the side edge of the front panel and securable adjacent to the third side panel through a closure mechanism such as a snap closure mechanism. Alternatively, the storage binder may have no fourth side panel and the third side panel may be hingedly attached to a side edge of the front panel. According to this alternative embodiment, the third side panel may be removably attachable to the back panel through the use of a closure mechanism.

The storage binder may also include a window display disposed on the exterior portion of the front panel. The panels of the storage binder form an enclosure to secure the loose-leaf inserts therein. An enclosed storage binder helps to mitigate the effects gravity may have on the loose-leaf inserts and their contents. An enclosed storage binder retains material that could accidentally fall out of the loose-leaf inserts and reduces the stress that gravity has on the binding portion of the loose-leaf inserts.

A loose-leaf binder insert used in a memorabilia storage binder is also disclosed. According to one embodiment the loose-leaf binder insert has two sides. A first side includes a transparent front sheet and a backing attached thereto. The front sheet and backing form one or more memorabilia-receiving sleeves between the front sheet and backing. A second side also includes a transparent front sheet and a backing attached thereto. The front sheet and backing also form one or more memorabilia-receiving sleeves between the front sheet and backing. An edge of the first side is attached to an edge of the second side so that the first and second sides may overlap to form the binder insert of the present invention. The two sides may overlap in such a manner so that the transparent front sheets are located on an outside of the binder insert. The binder insert may also include a binding portion that may be coupled to a retention mechanism on a storage binder. The binding portion may be reinforced through an additional strip of material.

According to one embodiment of the loose-leaf binder insert, each sleeve formed therein may have dimensions of either about 4″×6″, about 6″×6″, about 6″×8″, or about 12″×12″. Although these dimensions may be preferred for various reasons, loose-leaf binder inserts could have other dimensions to accommodate insertion of differently sized materials. Furthermore, according to another embodiment, one of the sleeves of the memorabilia-receiving sleeves of the loose-leaf insert may have a different dimension than another one of the sleeves on that loose-leaf insert. Moreover, the configuration of sleeves on the first side of the binder insert may have a different configuration than the sleeves on the second side of the binder insert.

The front sheet of the loose-leaf binder insert may be completely sealed to its corresponding backing such that no sleeve openings exist in either front sheet. The sleeve openings may be created in the first and second backings. Those sleeve openings may also be in a vertical orientation, such that each sleeve receives material from its side. Vertically-oriented sleeve openings prevent valuable or sentimental memorabilia from falling out of the openings when the storage binder is accidentally turned upside down. Also, having the openings in the backing further secures the contents in its respective sleeve.

In one embodiment, the first and second sides of the loose-leaf binder insert include a single transparent front sheet and a single backing that is folded in half to form the binder insert. A seam may be located along the fold created from the front sheet and backing being folded in half.

An alternative embodiment of a loose-leaf binder insert for use in a memorabilia storage binder is also disclosed. The loose-leaf binder insert may include a binding portion that is capable of being coupled to a retention mechanism on a storage binder. The loose-leaf binder insert may further include a display portion having a plurality of memorabilia-receiving sleeves. According to this embodiment, one sleeve of the memorabilia-receiving sleeves has a different dimension than that of another sleeve on the binder insert.

A memorabilia storage system is also disclosed. The storage system may include a storage binder that has a loose-leaf insert retaining mechanism and a plurality of panels arranged to form an enclosure. The storage system may also include a loose-leaf binder insert for placement in the storage binder. The binder insert may include a binding portion coupled to the retaining mechanism and a display portion having one or more memorabilia-receiving sleeves.

In one embodiment, the display portion of the binder insert has a plurality of memorabilia-receiving sleeves. One of those sleeves may have a different dimension than another sleeve thereon.

According to another embodiment, the binder insert may be constructed of a transparent front sheet attached to a backing to form more than one sleeve. The front sheet and backing may be folded in half to form the binder insert, such that the transparent front sheet is located on the outside of the binder insert.

According to one embodiment of the memorabilia storage system, each sleeve formed in the loose-leaf binder insert may have dimensions of either about 4″×6″, about 6″×6″, about 6″×8″, or about 12″×12″. The sleeves of the memorabilia storage system may include openings for each sleeve that are created in the backing. Those openings may be in a vertical orientation, such that each sleeve receives material from its side.

The memorabilia storage system may be adapted to store photographs in the sleeves. The storage system may also be adapted to store scrapbooking material. Moreover, the memorabilia storage system may be adapted to store compact discs. Consequently, the novel memorabilia storage system disclosed herein provides significant advantages over conventional systems because, among other things, its structure allows for uses in scrapbooking, photograph storing, and other memorabilia-storing uses.

### BRIEF DESCRIPTION OF THE SEVERAL VIEWS OF THE DRAWINGS

In order that the manner in which the above-recited and other features and advantages of the invention are obtained will be readily understood, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a perspective view of one embodiment of a memorabilia storage binder in a closed configuration;

FIG. 2 is a perspective view of the memorabilia storage binder of FIG. 1 in an open configuration;

FIG. 3 is a perspective view of an alternative embodiment of a memorabilia storage binder in an open configuration;

FIG. 4 is a perspective view of one embodiment of a memorabilia storage system having a storage binder and loose-leaf binder inserts placed therein;

FIG. 5 is a perspective view of one embodiment of a loose-leaf binder insert in an open configuration;

FIG. 6 is a perspective view of the loose-leaf binder insert of FIG. 5 in a closed configuration; and

FIGS. 7A to 7J are plan views of various exemplary configurations of sleeves according to ten different embodiments of a loose-leaf binder insert.

### DETAILED DESCRIPTION OF THE INVENTION

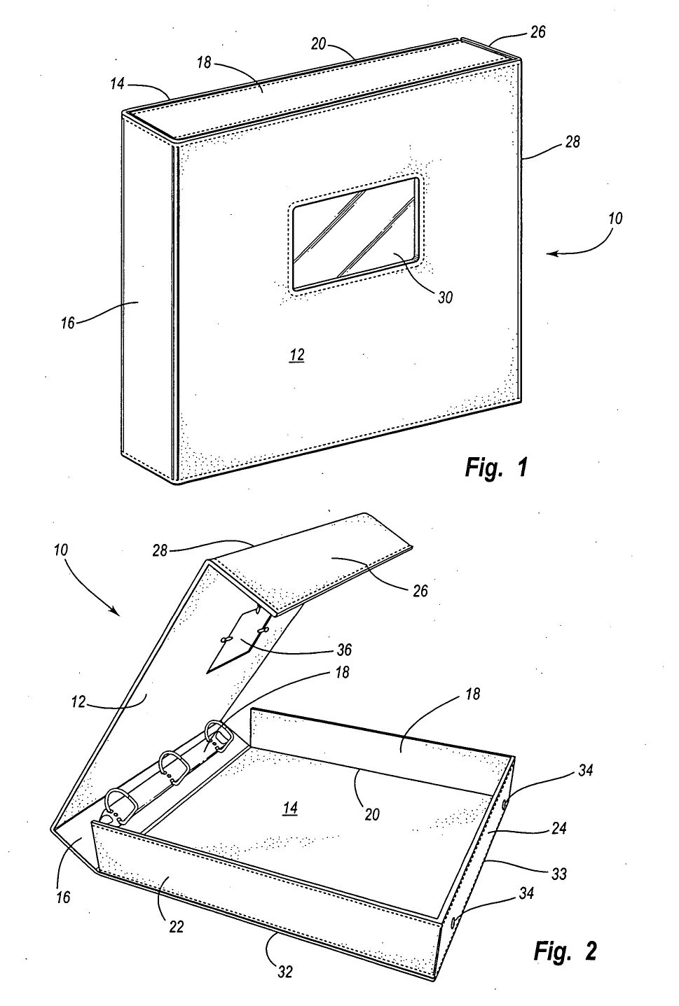

The presently preferred embodiments of the present invention will be best understood by reference to the drawings, wherein like parts are designated by like numerals throughout. It will be readily understood that the components of the present invention, as generally described and illustrated in the figures herein, could be arranged and designed in a wide variety of different configurations. Thus, the following more detailed description of the embodiments of the memorabilia storage system of the present invention, as represented in FIGS. 1 through 7J, is not intended to limit the scope of the invention, as claimed, but is merely representative of presently preferred embodiments of the invention.

The word “exemplary” is used exclusively herein to mean “serving as an example, instance, or illustration.” Any embodiment described herein as “exemplary” is not necessarily to be construed as preferred or advantageous over other embodiments. While the various aspects of the embodiments are presented in drawings, the drawings are not necessarily drawn to scale unless specifically indicated.

The phrases “connected to,” “coupled to” and “in communication with” refer to any form of interaction between two or more entities, including mechanical, electrical, magnetic, electromagnetic, fluid, and thermal interaction. Two components may be coupled to each other even though they are not in direct contact with each other.

The phrase “attached directly to” refers to a form of attachment by which the attached items are either in direct contact, or are only separated by a single fastener, adhesive, or other attachment mechanism. The term “abutting” refers to items that are in direct physical contact with each other, although the items may not be attached together. The phrase “integrally formed” refers to a body that is manufactured integrally, i.e., as a single piece, without requiring the assembly of multiple pieces. Multiple parts may be integrally formed with each other if they are formed from a single workpiece.

Referring to FIG. 1, a memorabilia storage binder 10 is depicted in a closed configuration from a perspective view. The storage binder 10 has a front panel 12 that is in a substantially parallel orientation with a back panel 14. A spine panel 16 is hingedly attached to both the front panel 12 and back panel 14. When the storage binder 10 is in its closed configuration, the spine panel 16 may be oriented in a substantially orthogonal or perpendicular relationship with the front 12 and back 14 panels.

The storage binder 10 also includes a first side panel 18 that may be rigidly attached to a top edge 20 of the back panel 14. Alternatively, the first side panel 18 may be attached to the front panel 12. With the first side panel 18 rigidly attached to the back panel 14, the first side panel 18 is oriented in a substantially orthogonal relationship with both the front 12 and back 14 panels, where it abuts, or nearly abuts the front panel 12 when the storage binder 10 is in its closed configuration. The storage binder 10 also includes second and third side panels (not shown) which will be discussed in greater detail in conjunction with FIG. 2.

When the storage binder 10 is in the closed configuration, the orientation of its panels creates an enclosure, so that the contents of the storage binder 10 are surrounded on all sides. This novel storage binder 10 provides an extra measure of protection for the binder's contents by reducing the stress that gravity has on the binding portion of loose-leaf inserts (not shown). It also prevents the unintentional loss of material that could fall out of the loose-leaf inserts if picked up or carried incorrectly, such as upside-down.

According to the embodiment depicted in FIG. 1, a fourth side panel 26 may be hingedly attached to a side edge 28 of the front panel 12, such that when the storage binder 10 is in the closed configuration, the fourth side panel 26 overlaps the third side panel (not shown). In the closed configuration the fourth side panel 26 is disposed in a substantially orthogonal orientation with respect to both the front panel 12 and back panel 14.

The panels of the storage binder 10 may be formed of any sufficiently durable material. For example, the storage binder 10 may be formed of leather (of any kind, including suede, imitation, etc.), fabric (linen, cotton, etc.), or plastic, or another suitable alternative material known to those having skill in the art.

The front panel 12 may optionally include a window display 30. The window display 30 may be formed in any number of configurations or sizes sufficient to selectively display visual material such as photographs or paper crafts and the like. The window display 30 may be accessed from the interior of the storage binder 10 such that visual material may be placed behind the plastic or glass or otherwise transparent material. Alternatively, the storage binder 10 may not have the depicted window display 30.

Referring to FIG. 2, the memorabilia storage binder 10 of FIG. 1 is depicted from a perspective view in an open configuration. The storage binder 10 has the front 12 and back panels 14 heretofore described. The spine panel 16 is shown hingedly attached to and interconnecting the front 12 and back 14 panels. In the open configuration, the spine panel 16 is no longer in a substantial orthogonal orientation to both the front 12 and back 14 panels. However, the first side panel 18 maintains its orthogonal orientation with respect to the back panel 14 because it is rigidly attached thereto.

According to the embodiment depicted, a second side panel 22 is also rigidly attached to the back panel 14 along its bottom edge 32. The second side panel 22 is disposed in a substantially orthogonal orientation with respect to the back panel 14. When the storage binder 10 is in its closed configuration (as shown in FIG. 1), the second side panel 22 is also substantially orthogonal with respect to the front panel 12.

A third side panel 24 may be rigidly attached to the back panel 14 along its side edge 33. The third side panel 24 is disposed in a substantially orthogonal orientation with respect to the back panel 14, and abuts, or nearly abuts both the first side panel 18 and the second side panel 22. On the exterior of the third side panel 24, two closure mechanisms 34 are positioned to receive corresponding parts (not shown) on the interior of the fourth side panel 26 to mate with the two closure mechanisms 34.

According to the present embodiment, the closure mechanisms 34 are snap closure mechanisms 34 wherein a male component may be located on the fourth side panel 26 and a female component may be located on the third side panel 24, or vice versa. The snap closure mechanisms 34 allow for retention of the panels of the storage binder 10 in a closed configuration. The snap closure mechanisms 34 secure the fourth side panel 26 adjacent to and overlapping the third side panel 24. A snap closure mechanism 34 is an exemplary device, and other forms of closure mechanisms may be used or none at all as appreciated by one having skill in the art. Examples of alternative closure mechanisms may comprise a strap closure, a latch closure, a button closure, a zipper closure, a ribbon closure, a hook and loop closure, and other conventional methods of closure known to those having skill in the art.

A display window access 36 may be located on the interior of the front panel 12 such that visual material may be placed behind the plastic or glass of the display window 30, as shown in FIG. 1.

The storage binder 10 of FIG. 2 includes a retaining mechanism 38 positioned along the length of the interior of the spine panel 16. The retaining mechanism 38 is configured to engage one or more openings formed in a loose-leaf insert or page (not shown). The retaining mechanism 38 of FIG. 2 is a three-pronged D-ring. Loose-leaf inserts having corresponding openings may be selectively introduced into the storage binder 10 and retained therein. However, alternative retaining mechanisms 38 may be utilized, such as rings, posts, tabs, rods and the like. These alternative retaining mechanisms are typically located along the length of the spine panel 16, and can be actuated to selectively retain loose-leaf inserts or pages as well.

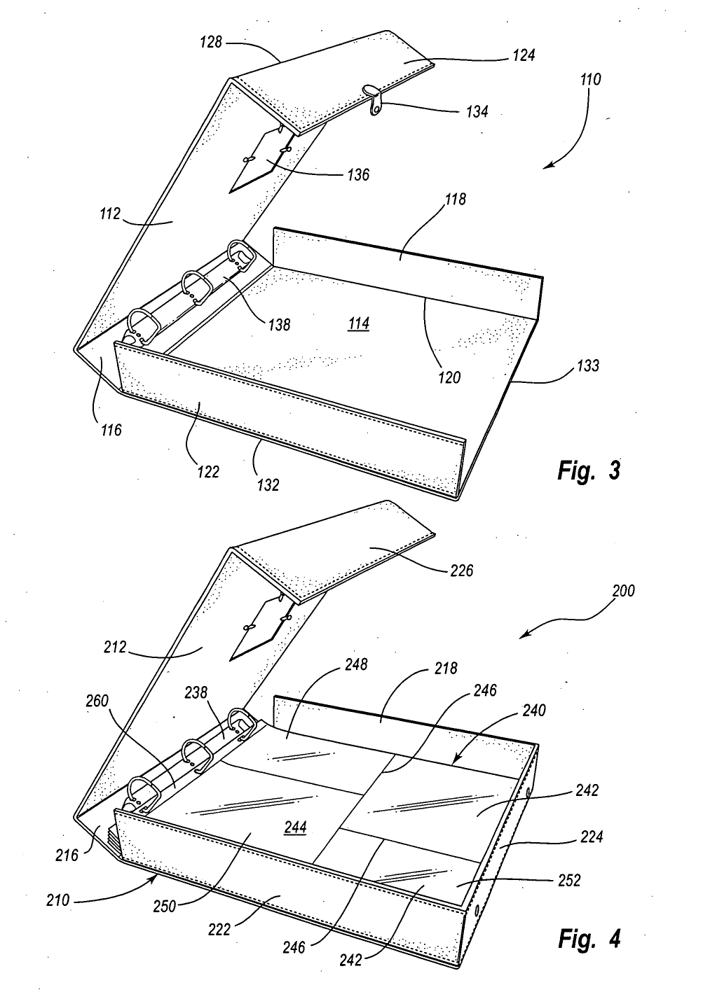

Referring to FIG. 3, another embodiment of a memorabilia storage binder 110 is shown from a perspective view in an open configuration. Like the storage binder 10 described in FIG. 2, the storage binder 110 of FIG. 3 has a front panel 112, a back panel 114, a spine panel 116, and a first 118 and second 122 side panels situated in a similar orientation as the embodiment described in conjunction with FIG. 2. The storage binder 10 also has a retaining mechanism 138 such as a three-pronged D-ring along the spine panel 116. The storage binder may also optionally include a display window access 136 for inserting visual material that may be viewed from the exterior face of the front panel 112.

However, the configuration of the side panels is different from the previous embodiment described. Like the previous embodiment, the first side panel 118 and second side panel 122 are oriented perpendicularly from the back panel 114 along its top 120 and bottom 132 edges, respectively. However the third side panel 124 is attached to the side edge 128 of the front panel 112 instead of the side edge 133 of the back panel 114. Furthermore, the third side panel 124 is hingedly, instead of rigidly attached to the front panel 112. According to this embodiment, no side panel exists along the side edge 133 of the back panel 114.

However, when the storage binder 110 is placed in its closed configuration, the closure mechanism 134 retains the third side panel 124 in a position adjacent the side edge 133 of the back panel 114 and the ends of the first 118 and second 122 side panels. This provides for a complete enclosure of the contents of the storage binder 110. The closure mechanism 134 may be a strap closure, or alternatively, by way of example, a snap closure, a latch closure, a button closure, a zipper closure, a ribbon closure, a hook and loop closure, or some other similar mechanism.

Although the storage binder 110 heretofore described may accept 12″×12″ loose-leaf inserts, the storage binder 110 may have alternative dimensions to house smaller or larger loose-leaf inserts. The dimension of the storage binder 110 heretofore described is merely illustrative of one present embodiment and is not intended to be limiting to any one size and/or dimension.

Referring to FIG. 4, one embodiment of a memorabilia storage system 200 is depicted from a perspective view. The memorabilia storage system 200 may include a memorabilia storage binder 210 and loose-leaf inserts 240 deposited therein. The storage binder 210 is shown in its open configuration. As with the storage binders heretofore described, the storage binder 210 of FIG. 4 has a front panel 212, a back panel (not shown), a spine panel 216 and first 218, second 222, third 224, and fourth 226 side panels, which in combination form an enclosure for the loose-leaf inserts 240.

The loose-leaf inserts 240 may have one or more receiving pockets or sleeves 242 for containing visual memorabilia, such as photographs, cardstock, other scrapbooking materials, paper crafts and the like, or other audio or audiovisual memorabilia. According to one embodiment, each sleeve 242 is formed between a backing (not shown) and a front sheet 244 which is constructed of an optically transparent material. Sealing lines 246 may be located, for example on three sides of each sleeve 242, however, other sealing line 246 configurations are considered within the scope of the memorabilia storage system 200 disclosed.

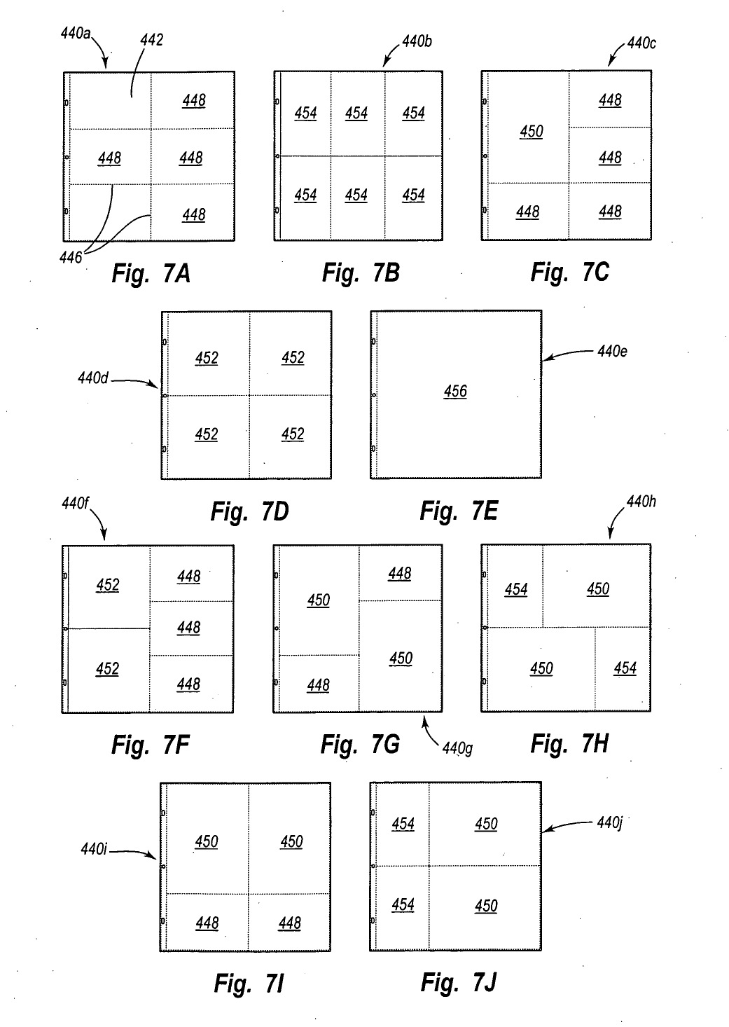

Sleeves 242 may be located on both the front and back of each loose-leaf insert 240. A variety of sleeve 242 sizes may be located on each loose-leaf insert 240, including a single sleeve that fills the space of the entire loose-leaf insert 240. Furthermore, the opposite side or back (not shown) of the loose-leaf insert 240 may have the same or an alternative configuration of sleeves 242 for receiving visual memorabilia. By way of example, the top loose-leaf insert 240 depicted within the storage binder 210 includes a horizontal 4″×6″ sleeve 248, a 6″×8″ sleeve 250, and two 6″×6″ sleeves 252. Alternative configurations of sleeves 242 are also contemplated and discussed in greater detail in conjunction with FIGS. 7A through 7J. The dimensions of each sleeve 242 may vary, and may further include, for example, a 12″×12″ sleeve and a vertical 4″×6″ sleeve. The foregoing dimensions of sleeves 242 are provided as illustrative of one present embodiment of the memorabilia storage system 200 and are not intended to be limiting to size and/or dimension.

According to an alternative embodiment, the loose-leaf inserts 240 may have a display portion that coincides with the front face 244, and a binding portion 260 for engagement with the retaining mechanism 238. The display portion may be constructed of a transparent material and have conventional sleeve openings oriented along the top edge of each sleeve 242. However, the binder insert 240 may have a novel configuration of sleeves 242 where one sleeve 242 has a different dimension than another. By way of example and not limitation, as discussed above, the loose-leaf insert 240 may include a horizontal 4″×6″ sleeve 248, a 6″×8″ sleeve 250, and two 6″×6″ sleeves 252.

Each sleeve 242 of the embodiments heretofore described may be sized to provide sufficient margins and space to facilitate the minor yielding of each sleeve 242 when multiple items are deposited therein, or when an item sized similarly to the dimensions of the sleeve 242 is deposited therein. For example, a 4″×6″ sleeve 248 may have dimensions slightly larger than four inches by six inches to facilitate the placement or removal of one or several 4″×6″ photographs therein. The slightly oversized configuration is beneficial because it is able to accommodate, for example, fully embellished scrapbooking layouts without the need to trim down pages to fit them into the loose-leaf inserts 240. According to this embodiment, extra photographs or negatives may also be inserted behind the desired display photograph, all in the same sleeve 242.

The memorabilia storage system 200 is a system that can be used in the context of scrapbooking, storing photographs, storing trading cards, or storing other visual or audio material such as negatives, compact discs, and similar material. The memorabilia storage system 200 may have sleeves 242 sized to receive and store photographs, such as the 4″×6″ horizontal sleeve 248. Alternatively, the storage system 200 may also have sleeves 242 sized to receive and store scrapbooking material, such as the 12″×12″ sleeve (not shown) or another dimension used often in scrapbooking. Furthermore, the storage system 200 may also have sleeves 242 sized to receive and store compact discs, DVDs, and other similarly-sized audio and/or audio-visual material, such as the 6″×6″ sleeve 252.

According to one embodiment of the present memorabilia storage system 200, a loose-leaf insert 240 may be formed having the same configuration of sleeves 242 on one side as the corresponding other side. As discussed previously, in the alternative, different configurations of sleeves 242 may be formed on one side relative to the corresponding other side. By way of example, and not by limitation, FIGS. 7A through 7J represent ten alternative configurations that may be used with the present memorabilia storage system 200.

According to the embodiment depicted in FIG. 4, the loose-leaf inserts 240 are constructed in such as manner as to engage a 3-ring retaining mechanism 238, such as a 3-pronged D-ring binding mechanism. Alternatively a multi-ring, post-bound, tab, rod or similar binding method may be used.

The loose-leaf insert 240 may include a binding portion 260 shaped to have a corresponding dimensional size and configuration as the storage binder 210 and correspondingly placed openings for engagement with the retaining mechanism 238. The binding portion 260 may be reinforced by adding an additional strip of material from which the display portion of the insert 240 is constructed. Alternatively, a more resilient strip of material may be used. The reinforcement of the binding portion 260 is advantageous in that it is able to better withstand stress placed on the insert 240 without the retaining mechanism 238 tearing through the binding portion 260.

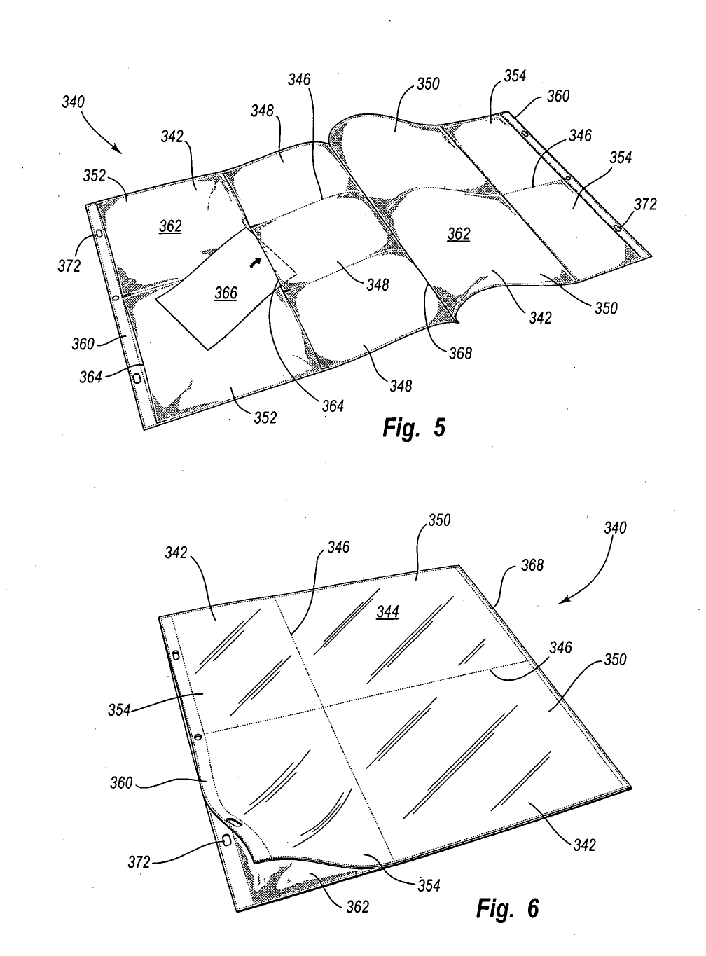

Referring to FIGS. 5 and 6, one embodiment of a loose-leaf binder insert 340 is depicted from a perspective view in an open configuration (FIG. 5) and a closed configuration (FIG. 6). The loose-leaf binder insert 340 may be constructed of one or more front sheets 344 made of an optically transparent material. According to one embodiment, the front sheet 344 does not have any openings created therein for insertion of photographs and other memorabilia. The front sheet 344 may have a smooth surface without open seams or loose edges, which protects the memorabilia inserted into each sleeve 342 from damage. The front sheet 344 comprises the outside, exposed portion on both sides of the loose-leaf binder insert 340 in the closed configuration, which, due to its transparent nature, displays the memorabilia contents placed within its sleeves 342.

Attached to the front sheet 344 along sealing lines 346 is a backing 362. The backing 362 may have a solid color or a printed design reproduced thereon. As will be appreciated by those having skill in the art, the backing 362 may be formed of a variety of materials, for example, cloth, plastic, paper, cardstock, or the like. The backing 362 is located on the interior portion of the loose-leaf binder insert 340 in the closed configuration.

Access to the sleeves 342 is provided via the backing 362. Sleeve openings 364 may be created in the backing 362 to allow insertion of photographs 366 and the like into the sleeve 342. Consequently, when the loose-leaf insert 340 is in the closed configuration, the openings 364 are inaccessible providing protection for the photographs 366 and other memorabilia that is deposited therein. Additionally, the openings 364 may be oriented in a vertical direction instead of a top-loading page protector of conventional systems. By way of orientation, the vertical direction is substantially parallel with the longitudinal direction of the binding portion 360. Vertical openings 364 provide for the insertion of photographs 366 and other memorabilia from the side. This helps to prevent the accidental removal of memorabilia from its corresponding sleeve when the loose-leaf insert 340 is turned upside-down.

Because the sleeves 342 of the loose-leaf inserts 340 load from the backing 362 side-facing each other in the closed configuration and snapped into a 3-ring D-ring binder, or similar retaining mechanism, the photographs 366 and other memorabilia that are inserted remain secure within the corresponding sleeve 342.

The loose-leaf binder insert 340 may be constructed of a first front sheet 344 attached to a first backing 362 and a second front sheet 344 attached to a second backing 362. The two front sheet 344—backing 362 pieces may be attached along an edge through a seam 368, seal, or other fastener or alternative attachment methods. This attachment method essentially creates a hinge giving the loose-leaf binder insert 340 a butterfly-fold configuration where the first and second front sheet 344—backing 362 pieces overlap in a closed configuration. In this butterfly-fold configuration the front sheets 344 are exposed on the exterior and the backing 362 is located on the interior of the loose-leaf insert 340 when in a closed configuration as shown in FIG. 6.

Alternatively, the loose-leaf binder insert 340 may be constructed of a single front sheet 344 that is attached to a single piece of backing 362. The front sheet 344 and backing 362 are then folded in half to create the loose-leaf insert 340 illustrated. A seam 368 may be placed along the fold to allow the two sides of the loose-leaf insert 340 to collapse into a closed configuration with an even, smooth profile.

The loose-leaf binder insert 340 may also have a binding portion 360 with retention member—receiving openings 372 to engage the retaining member (not shown) of the storage system. The binding portion 360 may be constructed of additional or more resilient material as reinforcement to prevent damage of the loose-leaf inserts 340 when engaged with the retaining member.

Also as noted above, one side of the loose-leaf insert 340 may have a different configuration of sleeves 342 than the other side. For example, the loose-leaf binder insert 340 depicted in FIGS. 5 and 6 have two 6″×6″ sleeves 352 and three horizontal 4″×6″ sleeves 348 on one side, and two 6″×8″ sleeves 350 and two vertical 4″×6″ sleeves 354 on the other side. Alternatively, each side of the loose-leaf insert 340 may have a similar sleeve configuration.

Referring to FIGS. 7A through 7J, various embodiments of loose-leaf binder inserts 440a-j are depicted from plan views. Each loose-leaf binder insert 440a-j shows, by way of example and not by limitation, a configuration of sleeves 442 that may be used in accordance with the present memorabilia storage system. Each sleeve 442 may be defined by the placement of sealing lines 446 on the binder insert 440.

FIG. 7A illustrates one embodiment of a loose-leaf binder insert 440a having six horizontal 4″×6″ sleeves 448.

FIG. 7B illustrates an alternative embodiment of a loose-leaf binder insert 440b having six vertical 4″×6″ sleeves 454.

FIG. 7C illustrates a third alternative embodiment of a loose-leaf binder insert 440c having one 6″×8″ sleeve 450 and four horizontal 4″×6″ sleeves 448.

FIG. 7D illustrates a fourth alternative embodiment of a loose-leaf binder insert 440d having four 6″×6″ sleeves 452.

FIG. 7E illustrates a fifth alternative embodiment of a loose-leaf binder insert 440e having one 12″×12″ sleeve 456.

FIG. 7F illustrates a sixth alternative embodiment of a loose-leaf binder insert 440f having two 6″×6″ sleeves 452 and three horizontal 4″×6″ sleeves 448.

FIG. 7G illustrates a seventh alternative embodiment of a loose-leaf binder insert 440g having two 6″×8″ sleeves 450 and two horizontal 4″×6″ sleeves 448.

FIG. 7H illustrates an eighth alternative embodiment of a loose-leaf binder insert 440h having two 6″×8″ sleeves 450 and two vertical 4″×6″ sleeves 454.

FIG. 7I illustrates a ninth alternative embodiment of a loose-leaf binder insert 440i having two 6″×8″ sleeves 450 and two horizontal 4″×6″ sleeves 448.

FIG. 7J illustrates a tenth alternative embodiment of a loose-leaf binder insert 440j having two 6″×8″ sleeves 450 and two vertical 4″×6″ sleeves 454.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

1-10. (canceled)

11. A loose-leaf binder insert for a memorabilia storage binder, comprising:
a first side comprising a transparent first front sheet and a first backing attached thereto forming at least one memorabilia-receiving sleeve between the first front sheet and first backing;
a second side comprising a transparent second front sheet and a second backing attached thereto forming at least one memorabilia-receiving sleeve between the second front sheet and second backing;
wherein an edge of the first side is attached to an edge of the second side so that the first and second sides overlap to form the binder insert, such that the transparent front sheets are located on an outside of the binder insert;
a first binding portion remote from the edge of the first side capable of coupling to a retention mechanism on a storage binder; and
a second binding portion remote from the edge of the second side capable of coupling to a retention mechanism on a storage binder.

12. The loose-leaf binder insert of claim 11, wherein a dimension of each memorabilia-receiving sleeve is selected from the group consisting of about four inches by six inches, about six inches by six inches, about six inches by eight inches, and about twelve inches by twelve inches.

13. The loose-leaf binder insert of claim 11, wherein one sleeve of the memorabilia-receiving sleeves has a different dimension than another sleeve of the memorabilia-receiving sleeves.

14. The loose-leaf binder insert of claim 11, wherein a configuration of sleeves on the first side of the binder insert is different than a configuration of sleeves on the second side of the binder insert.

15. The loose-leaf binder insert of claim 11, wherein each front sheet is sealed to its corresponding backing, such that no sleeve openings exist in either front sheet.

16. The loose-leaf binder insert of claim 11, wherein sleeve openings are created in the first and second backings.

17. The loose-leaf binder insert of claim 16, wherein the sleeve openings are vertically oriented, such that each sleeve receives material from its side.

18. The loose-leaf binder insert of claim 11, wherein the first and second sides comprise a single transparent front sheet and a single backing folded in half to form the binder insert.

19. The loose-leaf binder insert of claim 18, wherein a seam is located along a fold created from the front sheet and backing being folded in half.

20. The loose-leaf binder insert of claim 11, wherein the binding portion is reinforced through an additional strip of material.

21. A loose-leaf binder insert for a memorabilia storage binder, comprising:
a binding portion capable of coupling to a retention mechanism on a storage binder;
a display portion having a plurality of memorabilia-receiving sleeves; and
wherein one sleeve of the memorabilia-receiving sleeves has a different dimension than another sleeve of the memorabilia-receiving sleeves.

22. The loose-leaf binder insert of claim 21, wherein a dimension of each memorabilia-receiving sleeve is selected from the group consisting of about four inches by six inches, about six inches by six inches, about six inches by eight inches, and about twelve inches by twelve inches.

23. The loose-leaf binder insert of claim 21, wherein the binding portion is reinforced through an additional strip of material.

24. A memorabilia storage system, comprising:
a storage binder having a loose-leaf insert retaining mechanism and a plurality of panels arranged to form an enclosure; and
a loose-leaf binder insert for placement in the storage binder, the binder insert comprising a first binding portion for coupling to the retaining mechanism, a second binding portion for coupling to the retaining mechanism, and a display portion having at least one memorabilia-receiving sleeve, wherein the binder insert has an open configuration and a closed configuration and wherein the first binding portion is remote from the second binding portion in the open configuration, wherein the first binding portion is adjacent the second binding portion in the closed configuration.

25. The memorabilia storage binding system of claim 24, wherein the display portion of the binder insert has a plurality of memorabilia-receiving sleeves, such that one sleeve has a different dimension than another sleeve.

26. The memorabilia storage binding system of claim 24, wherein the binder insert is constructed of a transparent front sheet attached to a backing to form a plurality of sleeves, and the front sheet and backing is folded in half to form the binder insert, such that the transparent front sheet is located on the outside of the binder insert.

27. The memorabilia storage system of claim 26, wherein a dimension of each sleeve is selected from the group consisting of about four inches by six inches, about six inches by six inches, about six inches by eight inches, and about twelve inches by twelve inches.

28. The memorabilia storage system of claim 26, wherein openings to each sleeve of the plurality of sleeves are created in the backing.

29. The memorabilia storage system of claim 28, wherein the openings are in a vertical orientation, such that each sleeve receives material from its side.

30. The memorabilia storage system of claim 24, wherein the at least one sleeve is adapted to store photographs.

31. The memorabilia storage system of claim 24, wherein the at least one sleeve is adapted to store scrapbooking material.

32. The memorabilia storage system of claim 24, wherein the at least one sleeve is adapted to store compact discs.

33. A loose-leaf binder insert for a memorabilia storage binder, comprising:
a first binding portion for coupling to a retaining mechanism;
a second binding portion for coupling to the retaining mechanism;
a display portion having at least one memorabilia-receiving sleeve;
wherein the binder insert has an open configuration and a closed configuration;
wherein the first binding portion is remote from the second binding portion in the open configuration; and
wherein the first binding portion is adjacent the second binding portion in the closed configuration.

34. The loose-leaf binder insert of claim 33, wherein the display portion of the binder insert has a plurality of memorabilia-receiving sleeves, such that one sleeve has a different dimension than another sleeve.

35. The loose-leaf binder insert of claim 33, wherein the binder insert is constructed of a transparent front sheet attached to a backing to form a plurality of sleeves, and the front sheet and backing is folded in half to form the binder insert, such that the transparent front sheet is located on the outside of the binder insert.

36. The loose-leaf binder insert of claim 35, wherein a dimension of each sleeve is selected from the group consisting of about four inches by six inches, about six inches by six inches, about six inches by eight inches, and about twelve inches by twelve inches.

37. The loose-leaf binder insert of claim 35, wherein openings to each sleeve of the plurality of sleeves are created in the backing.

38. The loose-leaf binder insert of claim 37, wherein the openings are in a vertical orientation, such that each sleeve receives material from its side.
